(19) United States
(12) Patent Application Publication
(10) Pub. No.: US 2025/0273405 A1
(43) Pub. Date: Aug. 28, 2025

(54) CAPACITOR ELEMENT

(71) Applicant: Murata Manufacturing Co., Ltd., Nagaokakyo-shi (JP)

(72) Inventor: Katsuhiko TOKUDA, Nagaokakyo-shi (JP)

(21) Appl. No.: 19/206,270

(22) Filed: May 13, 2025

Related U.S. Application Data
(63) Continuation of application No. PCT/JP2023/039827, filed on Nov. 6, 2023.

(30) Foreign Application Priority Data
Nov. 18, 2022 (JP) 2022-184864

(51) Int. Cl. H01G 9/10; H01G 9/048; H01G 9/15

(52) U.S. Cl. CPC H01G 9/10; H01G 9/048; H01G 9/15

(57) ABSTRACT

A capacitor element that includes: a capacitor portion including: an anode plate having a core portion and a porous portion on at least one main surfaces of the core portion; a dielectric layer on a surface of the porous portion; and a cathode layer on a surface of the dielectric layer; a sealing layer covering the capacitor portion; and an outer electrode layer on a surface of the sealing layer and electrically coupled to the anode plate or the cathode layer. The outer electrode layer includes an opening penetrating the outer electrode layer in a thickness direction.

### CROSS REFERENCE TO RELATED APPLICATIONS

The present application is a continuation of International application No. PCT/JP2023/039827, filed Nov. 6, 2023, which claims priority to Japanese Patent Application No. 2022-184864, filed Nov. 18, 2022, the entire contents of each of which are incorporated herein by reference.

### TECHNICAL FIELD

The present disclosure relates to a capacitor element.

### BACKGROUND ART

Patent Document 1 discloses a capacitor array that includes plural solid electrolytic capacitor elements formed by partitioning a single solid electrolytic capacitor sheet, a sheet-like first sealing layer, and a sheet-like second sealing layer. The solid electrolytic capacitor sheet includes: an anode plate made of a valve metal; a porous layer provided on at least one of the main surfaces of the anode plate; a dielectric layer provided on the surface of the porous layer; and a cathode layer including a solid electrolytic layer provided on the surface of the dielectric layer. The solid electrolytic capacitor sheet includes a first main surface and a second main surface that face each other in the thickness direction. The first main surface's side of each of the plural solid electrolytic capacitor elements is arranged on the first sealing layer. The second sealing layer is arranged so as to cover the second main surface's side of the plural solid electrolytic capacitor elements on the first sealing layer. The solid electrolytic capacitor elements are separated by slit-shaped sheet-removal portions.
Patent Document 1: Japanese Unexamined Patent Application Publication No. 2020-167361

### SUMMARY OF THE DISCLOSURE

Patent Document 1 describes that outer electrodes coupled to the anode plate or the cathode layer may be provided outside the first or second sealing layer. Furthermore, Patent Document 1 describes that it is preferable that a via electrode penetrating the first or second sealing layer in the thickness direction is provided and the anode plate or cathode layer is coupled to the outer electrodes through the via electrode.

However, when the outer electrodes are provided outside the sealing layer, moisture contained in the solid electrolytic capacitor elements is less likely to escape. Therefore, rapid evaporation of moisture can cause peel-off called delamination, for example, peel-off of the cathode layer from the anode plate.

The aforementioned problem occurs not only in structures where multiple capacitor portions are arranged between the sealing layers but also in structures where a single capacitor portion is arranged between the sealing layers.

The present disclosure has been made to solve the aforementioned problem, and an object of the present disclosure is to provide a capacitor element in which delamination due to rapid evaporation of moisture is reduced.

A capacitor element of the present disclosure includes: a capacitor portion including: an anode plate having a core portion and a porous portion on at least one main surface of the core portion; a dielectric layer on a surface of the porous portion; and a cathode layer on a surface of the dielectric layer; a sealing layer covering the capacitor portion; and an outer electrode layer on a surface of the sealing layer and electrically coupled to the anode plate or the cathode layer, wherein the outer electrode layer includes at least one opening penetrating the outer electrode layer in a thickness direction thereof.

According to the present disclosure, it is possible to provide a capacitor element in which delamination due to rapid evaporation of moisture is reduced.

### BRIEF DESCRIPTION OF DRAWINGS

FIG. 1 is a schematic sectional view of an example of a capacitor element according to a first embodiment of the present disclosure.

FIG. 2 is a plan view of the capacitor element illustrated in FIG. 1 taken along line A-A.

FIG. 3 is a schematic sectional view of another example of a capacitor element according to the first embodiment of the present disclosure.

FIG. 4 is a schematic plan view of an example of an opening having only linear shapes.

FIG. 5 is a schematic plan view of an example of an opening having a shape that combines straight lines and curves.

FIG. 6 is a schematic plan view of an example of a capacitor element according to a second embodiment of the present disclosure.

FIG. 7 is a schematic plan view of an example of a capacitor element according to a third embodiment of the present disclosure.

FIG. 8 is a schematic plan view of another example of a capacitor element according to the third embodiment of the present disclosure.

FIG. 9 is a schematic plan view of an example of a capacitor element according to a fourth embodiment of the present disclosure.

FIG. 10 is a schematic plan view of an example of a capacitor element according to a fifth embodiment of the present disclosure.

FIG. 11 is a schematic plan view of regions from which internal moisture escapes in the capacitor element illustrated in FIG. 10.

FIG. 12 is a schematic plan view of another example of a capacitor element according to the fifth embodiment of the present disclosure.

FIG. 13 is a schematic plan view of regions from which internal moisture escapes in the capacitor element illustrated in FIG. 12.

FIG. 14 is a schematic plan view of an example of a capacitor element according to a sixth embodiment of the present disclosure.

FIG. 15 is a schematic plan view of regions from which internal moisture escapes in the capacitor element illustrated in FIG. 14.

FIG. 16 is a schematic plan view of a capacitor element according to a first modification of the sixth embodiment of the present disclosure.

FIG. 17 is a schematic plan view of a capacitor element according to a second modification of the sixth embodiment of the present disclosure.

FIG. 18 is a schematic plan view of a capacitor element according to a third modification of the sixth embodiment of the present disclosure.

FIG. 19 is a schematic plan view of a capacitor element according to a fourth modification of the sixth embodiment of the present disclosure.

FIG. 20 is a schematic plan view of an example of a capacitor element according to a seventh embodiment of the present disclosure.

FIG. 21 is a schematic plan view of an example of a capacitor element according to an eighth embodiment of the present disclosure.

### DESCRIPTION OF THE PREFERRED EMBODIMENTS

Hereinafter, capacitor elements of the present disclosure will be described. The present disclosure is not limited to the configurations described below and may be properly changed without changing the gist of the present disclosure. The present disclosure also includes combinations of preferred configurations described below.

Each embodiment described below is illustrative, and it is obvious that configurations illustrated in different embodiments can be partially replaced or combined with each other. In the second and subsequent embodiments, the description of the same matters as the first embodiment will be omitted, and different points will be mainly described. In particular, similar operational effects resulting from the same configuration will not be described repeatedly for each embodiment.

In the following description, when each embodiment is not specifically distinguished, it is simply referred to as a “capacitor element of the present disclosure”.

In this specification, terms that describe the relationship between elements (for example, “vertical”, “parallel”, and “perpendicular”), as well as terms that describe the shape of elements, are not expressions of only strict meaning but are expressions meaning substantially equivalent scopes, allowing for variations of about several percent. In this specification, “equivalent” does not only mean “completely equivalent” but also allows for variations of, for example, about several percent.

The drawings below are schematic, and the scales of dimensions, aspect ratios, and the like may be different from those of actual products. In the drawings, identical or equivalent portions are given the same reference numerals. In each drawing, identical elements are given the same reference numeral, and redundant descriptions thereof will be omitted.

### First Embodiment

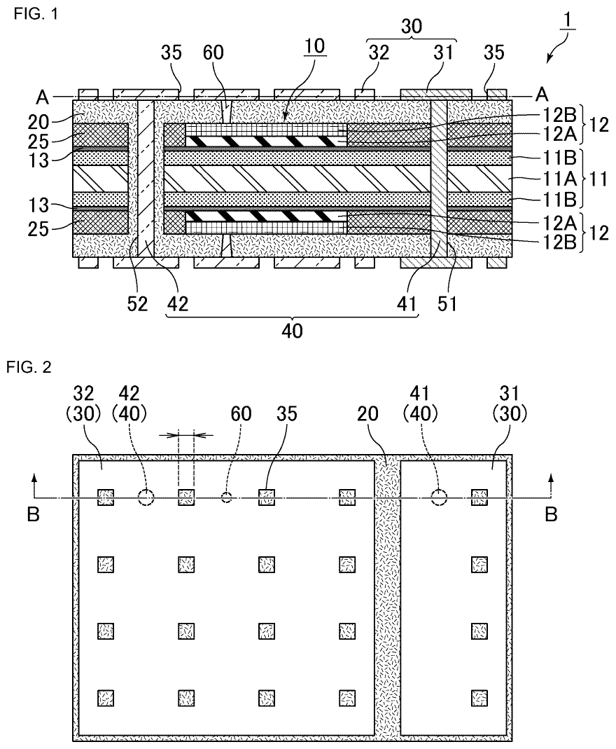

FIG. 1 is a schematic sectional view of an example of a capacitor element according to a first embodiment of the present disclosure. FIG. 2 is a plan view of the capacitor element illustrated in FIG. 1 taken along line A-A. FIG. 1 is a sectional view of the capacitor element illustrated in FIG. 2 taken along line B-B.

The capacitor element 1 illustrated in FIGS. 1 and 2 includes a capacitor portion 10, a sealing layer 20, and outer electrode layers 30. The sealing layer 20 is provided so as to cover the capacitor portion 10. The outer electrode layers 30 are each provided on the surface of the sealing layer 20.

In the example illustrated in FIGS. 1 and 2, one capacitor portion 10 is arranged inside the sealing layer 20. The number of capacitor portions 10 arranged inside the sealing layer 20 is not particularly limited and may be one or more.

The capacitor portion 10 includes an anode plate 11, a dielectric layer 13, and a cathode layer 12. The anode plate 11 includes a porous portion 11B on at least one of the main surfaces of a core portion 11A. The dielectric layer 13 is provided on the surface of the porous portion 11B. The cathode layer 12 is provided on the surface of the dielectric layer 13. The capacitor portion 10 thereby constitutes an electrolytic capacitor. In the example illustrated in FIG. 1, the anode plate 11 includes porous portions 11B on the respective main surfaces of the core portion 11A. However, the anode plate 11 may include one porous portion 11B on only one of the main surfaces of the core portion 11A.

The cathode layer 12 includes, for example, a solid electrolytic layer 12A, which is provided on the surface of the dielectric layer 13. Preferably, the cathode layer 12 further includes a conductor layer 12B, which is provided on the surface of the solid electrolytic layer 12A. When the cathode layer 12 includes the solid electrolytic layer 12A, the capacitor portion 10 constitutes a solid electrolytic capacitor.

Preferably, the sealing layer 20 is provided on each of the main surfaces of the capacitor portion 10 that face each other in the thickness direction as illustrated in FIG. 1. The capacitor portion 10 is protected by the sealing layer 20.

The sealing layer 20 may be composed of either a single layer or multiple layers. When the sealing layer 20 is composed of multiple layers, the materials constituting the multiple layers may be the same or different.

The sealing layer 20 is formed so as to seal the capacitor portion 10 by, for example, a method of thermocompression bonding an insulating resin sheet, a method of applying insulating resin paste and thermosetting the paste, or another method.

The outer electrode layers 30 include, for example, a first outer electrode layer 31 and a second outer electrode layer 32. The first outer electrode layer 31 is electrically coupled to the anode plate 11, and the second outer electrode layer 32 is electrically coupled to the cathode layers 12.

For one capacitor portion 10, either one first outer electrode layer 31 or plural first outer electrode layers 31 may be provided. Similarly, for one capacitor portion 10, either one second outer electrode layer 32 or plural second outer electrode layers 32 may be provided. The number of first outer electrode layers 31 provided for one capacitor portion 10 may be the same as or different from the number of second outer electrode layers 32.

The planar shape of the outer electrode layers 30 when viewed in the thickness direction is not particularly limited, and examples thereof include rectangles (squares or oblongs), quadrilaterals other than rectangles, polygons such as triangles, pentagons, and hexagons, as well as circles, ellipses, and combinations of these shapes. The planar shape of the outer electrode layers 30 may be L-shaped, C-shaped (U-shaped), stair-shaped, or the like.

The planar shape of the first outer electrode layer 31 when viewed in the thickness direction may be the same as or different from that of the second outer electrode layer 32 when viewed in the thickness direction.

As illustrated in FIGS. 1 and 2, openings 35 are provided in at least one of the outer electrode layers 30. The openings 35 penetrate the outer electrode layers 30 in the thickness direction. In the example illustrated in FIGS. 1 and 2, plural openings 35 are provided in both the first and second outer electrode layers 31 and 32.

When the openings 35 are provided in the outer electrode layers 30, the sealing layer 20 is partially exposed to the surface. The sealing layer 20 has a larger water vapor transmission rate (WVTR) than the outer electrode layers 30, and paths for moisture contained in the capacitor portion 10 to escape are thereby ensured. As a result, it is possible to reduce delamination due to rapid evaporation of moisture.

The openings 35 are formed by, for example, applying a method, such as photolithography and etching, to the outer electrode layers 30.

The planar shape of the openings 35 when viewed in the thickness direction is not particularly limited, and examples thereof include rectangles (squares or oblongs), quadrilaterals other than rectangles, polygons such as triangles, pentagons, and hexagons, as well as circles, ellipses, and combinations of these shapes. The planar shape of the outer electrode layers 30 may be V-shaped, cross-shaped, or the like.

When the openings 35 are provided in both the first and second outer electrode layers 31 and 32, the planar shape, size, and the like of the openings 35 in the first outer electrode layer 31 may be the same as or different from those in the second outer electrode layer 32.

It is preferable that at least one of the outer electrode layers 30 is provided with plural openings 35. In this case, the plural openings 35 are more likely to ensure moisture escape paths. The openings 35 may have the same planar shape, or some or all of them may have different planar shapes.

When the sealing layer 20 is provided on each of the main surfaces of the capacitor portion 10 that face each other in the thickness direction and the outer electrode layers 30 are provided on the sealing layer 20 on each of the main surfaces, it is preferable that the openings 35 are provided in the outer electrode layers 30 on respective sides of the capacitor portion 10. In this case, moisture escape paths are more easily ensured on both sides of the capacitor portion 10. On both sides of the capacitor portion 10, the planar shape, size, number, positions, and the like of the openings 35 may be the same, or some or all of them may be different.

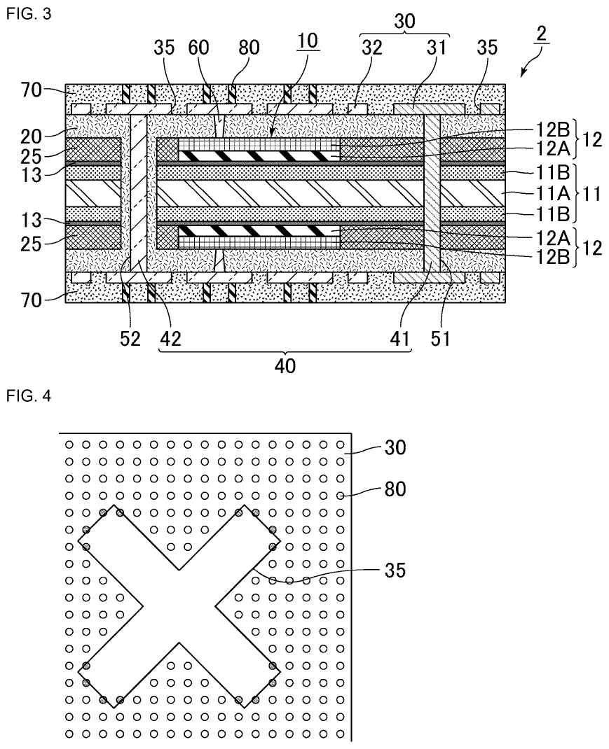

The larger the area of the openings 35, the easier it is to ensure moisture escape paths. It is therefore preferable that in plan view in the thickness direction, the area of the openings 35 is greater than or equal to 5% of the area enclosed by the peripheral edge of the outer electrode layer 30 provided with these openings 35. On the other hand, the larger the area of the openings 35, the narrower the region where later-described outer via conductors 80 (see FIG. 3) can be formed. It is therefore preferable that in plan view in the thickness direction, the area of the openings 35 is smaller than or equal to 50% of the area enclosed by the peripheral edge of the outer electrode layer 30 provided with these openings 35.

“The area enclosed by the peripheral edge of the outer electrode layer 30 provided with these openings 35” means the total area enclosed by the peripheral edge of the outer electrode layer 30, including the area of the openings 35.

The larger the maximum width of the openings 35, the easier it is to ensure moisture escape paths. It is therefore preferable that in plan view in the thickness direction, the maximum width of the openings 35 is greater than or equal to 5% of the length of the short side of the outer electrode layer 30 provided with these openings 35. On the other hand, the larger the maximum width of the openings 35, the narrower the region where the later-described outer via conductors 80 (see FIG. 3) can be formed. It is therefore preferable that in plan view in the thickness direction, the maximum width of the openings 35 is smaller than or equal to 90% of the length of the short side of the outer electrode layer 30 provided with these openings 35. Furthermore, in plan view in the thickness direction, the maximum width of the openings 35 may be smaller than or equal to 50% of the length of the short side of the outer electrode layer 30 provided with these openings 35.

For example, the maximum width of the openings 35 is preferably greater than or equal to 10 μm in plan view in the thickness direction. On the other hand, the maximum width of the openings 35 is preferably smaller than or equal to 20 mm in plan view in the thickness direction.

Preferably, the capacitor element 1 further includes through-hole conductors 40, each of which is provided so as to penetrate the capacitor portion 10 and sealing layer 20 in the thickness direction and has ends each exposed to the surface of the sealing layer 20.

In the example illustrated in FIG. 1, the through-hole conductors 40 include a first through-hole conductor 41 and a second through-hole conductor 42. The first through-hole conductor 41 is electrically coupled to the anode plate 11, and the second through-hole conductor 42 is electrically coupled to the cathode layers 12. The through-hole conductors 40 may include both the first and second through-hole conductors 41 and 42 or may include either one.

The first through-hole conductor 41 needs to be provided on at least the inner wall surface of a first through-hole 51, which penetrates the capacitor portion 10 and sealing layer 20 in the thickness direction. The first through-hole conductor 41 may be provided only on the inner wall surface of the first through-hole 51 or may be provided throughout the entire interior of the first through-hole 51.

As illustrated in FIG. 1, preferably, the first through-hole conductor 41 is electrically coupled to the anode plate 11 through the inner wall surface of the first through-hole 51.

In plan view in the thickness direction, one first through-hole conductor 41 may be provided inside the cathode layers 12, or two or more first through-hole conductors 41 may be provided.

The second through-hole conductor 42 needs to be provided on at least the inner wall surface of a second through-hole 52, which penetrates the capacitor portion 10 and sealing layer 20 in the thickness direction. The second through-hole conductor 42 may be provided only on the inner wall surface of the second through-hole 52 or may be provided throughout the entire interior of the second through-hole 52.

As illustrated in FIG. 1, it is preferable that the space between the second through-hole conductor 42 and the capacitor portion 10 is filled with an insulating material constituting, for example, the sealing layer 20.

In plan view in the thickness direction, one second through-hole conductor 42 may be provided inside the cathode layers 12, or two or more second through-hole conductors 42 may be provided.

The through-hole conductors 40 may include a third through-hole conductor (not illustrated in FIG. 1) that is not electrically coupled to either the anode plate 11 or the cathode layers 12.

Preferably, the capacitor element 1 further includes inner via conductors 60, each of which is provided so as to penetrate the sealing layer 20 in the thickness direction and has an end exposed to the surface of the sealing layer 20.

In the example illustrated in FIG. 1, the inner via conductors 60 are electrically coupled to the cathode layers 12. The cathode layers 12 are thereby electrically led out to the outside of the sealing layer 20 through the inner via conductors 60 and can be electrically coupled to the outside of the sealing layer 20. The number of inner via conductors 60 electrically coupled to each of the cathode layers 12 may be one or more.

The capacitor element 1 may include an inner via conductor 60 (not illustrated in FIG. 1) that is electrically coupled to the anode plate 11. In this case, the anode plate 11 is electrically led out to the outside of the sealing layer 20 through the inner via conductor 60 and can be electrically coupled to the outside of the sealing layer 20. The number of inner via conductors 60 electrically coupled to the anode plate 11 may be one or more.

When the through-hole conductors 40 are provided inside the sealing layer 20, it is preferable that the capacitor portion 10 further includes an insulating mask layer 25, which is provided around the through-hole conductors 40 on at least one of the main surfaces of the anode plate 11.

In the example illustrated in FIG. 1, insulating mask layers 25 are provided between the first through-hole conductor 41 and the respective cathode layers 12. Furthermore, in the example illustrated in FIG. 1, the space between the second through-hole conductor 42 and the capacitor portion 10 is filled with an insulating material constituting, for example, the sealing layer 20, and the insulating mask layers 25 are provided between this insulating material and the respective cathode layers 12.

The capacitor portion 10 may further include an insulating mask layer 25 provided on at least one of the main surfaces of the anode plate 11 so as to surround the periphery of the corresponding cathode layer 12. The insulating mask layer 25 that surrounds the periphery of the cathode layer 12 ensures insulation between the anode plate 11 and the cathode layer 12, thus preventing a short circuit therebetween. The insulating mask layer 25 may be provided so as to surround part of the periphery of the cathode layer 12 but is preferably provided so as to surround the entire periphery of the cathode layer 12.

FIG. 3 is a schematic sectional view of another example of a capacitor element according to the first embodiment of the present disclosure.

A capacitor element 2 illustrated in FIG. 3 includes: the capacitor portion 10; the sealing layer 20, which is provided so as to cover the capacitor portion 10; the outer electrode layers 30, which are provided on the surface of the sealing layer 20; and an outer insulating layer 70. The outer insulating layer 70 is provided so as to cover the sealing layer 20 and outer electrode layers 30.

The outer insulating layer 70 is formed by, for example, placing the capacitor element 1 illustrated in FIG. 1 in a cavity previously provided in a substrate and filling the cavity with insulating resin.

Alternatively, the outer insulating layer 70 may be formed by, for example, attaching cured prepreg to the capacitor element 1 illustrated in FIG. 1 with an adhesive layer interposed therebetween.

The outer insulating layer 70 may be composed of either a single layer or multiple layers. When the outer insulating layer 70 is composed of multiple layers, the materials constituting the multiple layers may either be the same or different.

The outer insulating layer 70 may be provided only on one side in the thickness direction or may be provided on each side. When outer insulating layers 70 are provided on respective sides in the thickness direction, the thicknesses of the outer insulating layers 70 provided on the respective sides may either be the same or different.

Preferably, the capacitor element 2 further includes outer via conductors 80, each of which is provided so as to penetrate the corresponding outer insulating layer 70 in the thickness direction and has an end coupled to the corresponding outer electrode layer 30.

In the example illustrated in FIG. 3, an end of each outer via conductor 80 is coupled to the second outer electrode layer 32. The capacitor element 2 also includes an outer via conductor 80 with an end coupled to the first outer electrode layer 31 (not illustrated in FIG. 3). The number of outer via conductors 80 electrically coupled to the first outer electrode layer 31 may be one or more. Similarly, the number of outer via conductors 80 electrically coupled to the second outer electrode layer 32 may be one or more.

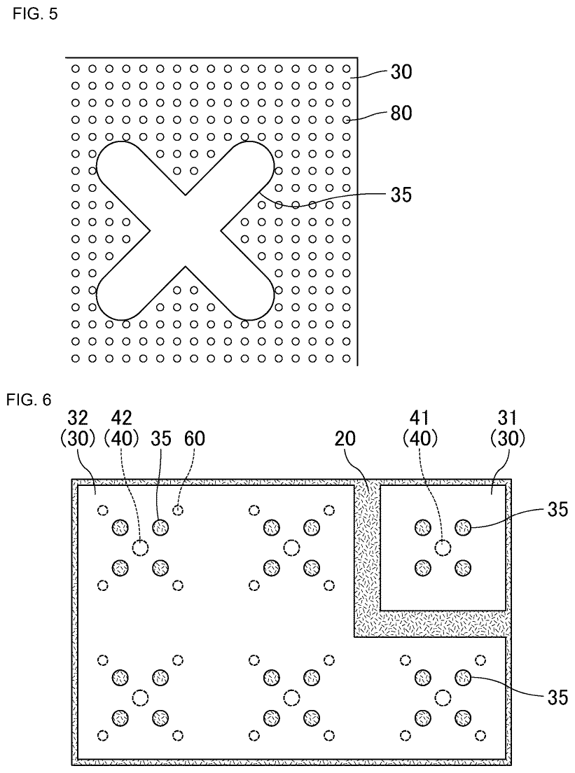

FIG. 4 is a schematic plan view of an example of an opening having only linear shapes. FIG. 5 is a schematic plan view of an example of an opening having a shape that combines straight lines and curves.

In plan view in the thickness direction, each opening 35 may have only linear shapes as illustrated in FIG. 4 or may have a shape that combines straight lines and curves as illustrated in FIG. 5.

When the openings 35 have a shape that combines straight lines and curves, for example, the openings 35 can be easily arranged to avoid the through-hole conductors 40, inner via conductors 60, and outer via conductors 80.

As illustrated in FIG. 5, each opening 35 may have a rounded tip in plan view in the thickness direction. In the case of FIG. 4, it is difficult to form the outer via conductors 80 (indicated by black dots in FIG. 4) in the vicinity of the tips of the openings 35. In the case illustrated in FIG. 5, the outer via conductors 80 can be formed also in the vicinity of the tips of the openings 35. Furthermore, when the openings 35 are formed by photolithography, the tips of the openings 35 can easily be rounded.

In the example illustrated in FIG. 4, the planar shape of the opening 35 is a cross shape but is not particularly limited to the linear shapes. Similarly, in the example illustrated in FIG. 5, the planar shape of the opening 35 is a cross shape but is not particularly limited to the shape that combines straight lines and curves.

### Second Embodiment

FIG. 6 is a schematic plan view of an example of a capacitor element according to a second embodiment of the present disclosure.

As illustrated in FIG. 6, it is preferable that the openings 35 do not overlap the through-hole conductors 40 in plan view in the thickness direction. In the example illustrated in FIG. 6, the openings 35 provided in the first outer electrode layer 31 do not overlap the first through-hole conductors 41, and the openings 35 provided in the second outer electrode layer 32 do not overlap the second through-hole conductors 42.

Furthermore, it is preferable that the openings 35 do not overlap the inner via conductors 60 in plan view in the thickness direction. In the example illustrated in FIG. 6, the openings 35 provided in the second outer electrode layer 32 do not overlap the inner via conductors 60.

When the openings 35 are arranged so as not to overlap the extended conductors, such as the through-hole conductors 40 and the inner via conductors 60, internal conduction paths can be ensured.

When plural openings 35 are provided, the plural openings 35 may include an opening 35 that overlaps one of the through-hole conductors 40 and may include an opening 35 that overlaps one of the inner via conductors 60 but does not overlap any one of the through-hole conductors 40.

### Third Embodiment

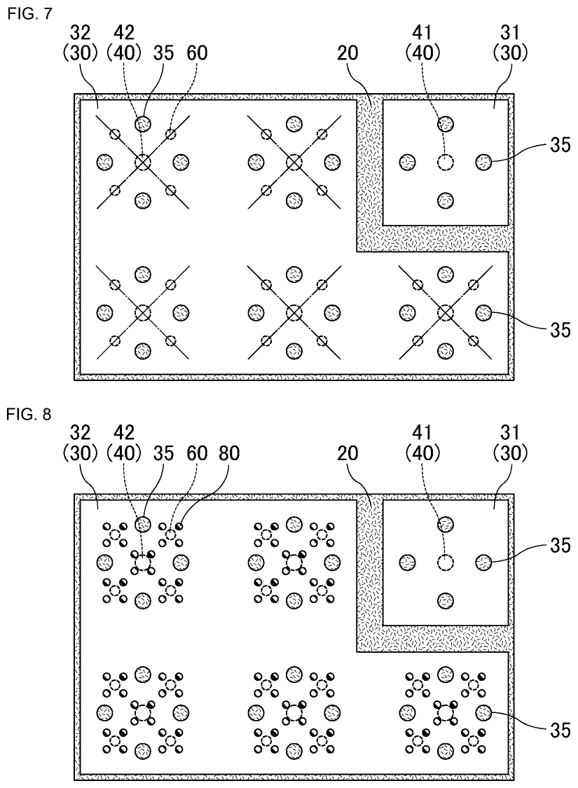

FIG. 7 is a schematic plan view of an example of a capacitor element according to a third embodiment of the present disclosure.

As illustrated in FIG. 7, in plan view in the thickness direction, it is preferable that the openings 35 provided in the outer electrode layer 30 that encloses the through-hole conductors 40 and inner via conductors 60 are not located on line segments connecting the through-hole conductors 40 to the inner via conductors 60. In the example illustrated in FIG. 7, the openings 35 provided in the second outer electrode layer 32 are not located on line segments connecting each second through-hole conductor 42 to the inner via conductors 60.

When the openings 35 are arranged so as not to be located on the line segments connecting the through-hole conductors 40 to the inner via conductors 60, it is possible to prevent the loss of the outer electrode layers 30 on the shortest path of electric current flowing therebetween and minimize its contribution to the electric resistance.

In the example illustrated in FIG. 7, the line segments connecting the through-hole conductors 40 to the inner via conductors 60 are inclined at about 450 to the edge of the corresponding outer electrode layer 30 but may be parallel or perpendicular to the edge of the corresponding outer electrode layer 30, for example.

When plural openings 35 are provided, the plural openings 35 may include an opening that is located on any one of the line segments connecting the through-hole conductors 40 and the inner via conductors 60.

FIG. 8 is a schematic plan view of another example of a capacitor element according to the third embodiment of the present disclosure.

As illustrated in FIG. 8, when the outer via conductors 80 are provided, it is preferable that the openings 35 do not overlap the outer via conductors 80 in plan view in the thickness direction. In the example illustrated in FIG. 8, the openings 35 provided in the second outer electrode layer 32 do not overlap the outer via conductors 80. The openings 35 provided in the first outer electrode layer 31 do not need to overlap the outer via conductors 80 (not illustrated in FIG. 8).

When the openings 35 are arranged so as not to overlap the outer via conductors 80, external conduction paths can be ensured.

When plural openings 35 are provided, the plural openings 35 may include an opening 35 that overlaps any one of the outer via conductors 80.

Preferably, the openings 35 provided in the outer electrode layer 30 that encloses the through-hole conductors 40 are not located on the line segments connecting the through-hole conductors 40 to the outer via conductors 80 in plan view in the thickness direction. In the example illustrated in FIG. 6, the openings 35 provided in the second outer electrode layer 32 are not located on the line segments connecting the outer via conductors 80 to the second through-hole conductor 42.

When the openings 35 are arranged so as not to be located on the line segments connecting the outer via conductors 80 to the through-hole conductors 40, it is possible to prevent the loss of the outer electrode layers 30 on the shortest path of electric current flowing therebetween and minimize its contribution to the electric resistance.

When plural openings 35 are provided, the plural openings 35 include an opening 35 that is located on any one of the line segments connecting the outer via conductors 80 to the through-hole conductors 40.

Furthermore, it is preferable that the openings 35 provided in the outer electrode layer 30 that encloses the inner via conductors 60 are not located on the line segments connecting the outer via conductors 80 to the inner via conductors 60 in plan view in the thickness direction. In the example illustrated in FIG. 6, the openings 35 provided in the second outer electrode layer 32 are not located on the line segments connecting the outer via conductors 80 to the inner via conductors 60.

When the openings 35 are arranged so as not to be located on the line segments connecting the outer via conductors 80 to the inner via conductor 60, it is possible to prevent the loss of the outer electrode layers 30 on the shortest path of electric current flowing therebetween and minimize its contribution to the electric resistance.

When plural openings 35 are provided, the plural openings 35 may include an opening 35 that is located on any one of the line segments connecting the outer via conductors 80 to the inner via conductors 60.

### Fourth Embodiment

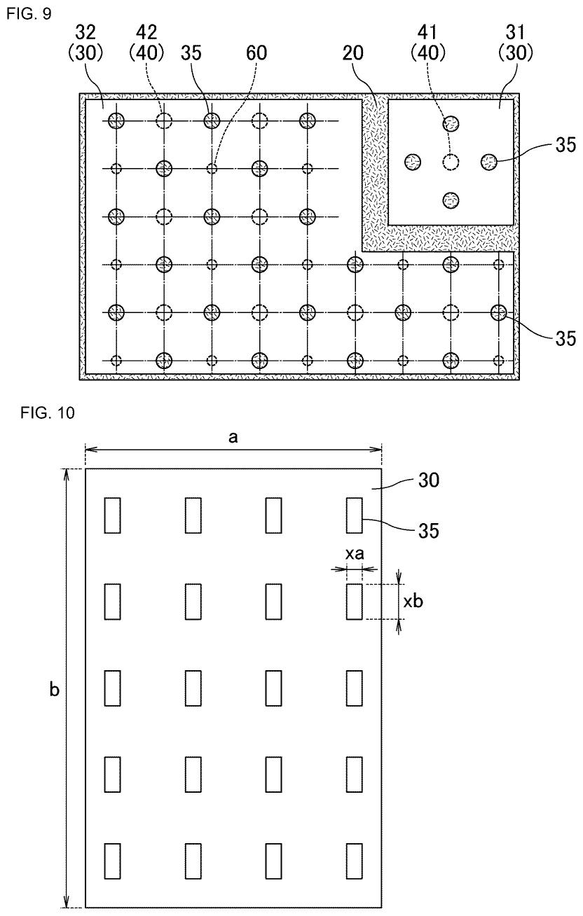

FIG. 9 is a schematic plan view of an example of a capacitor element according to a fourth embodiment of the present disclosure.

As illustrated in FIG. 9, in plan view in the thickness direction, the openings 35 provided in the outer electrode layer 30 that encloses the through-hole conductors 40 and inner via conductors 60 may pass through the midpoints of the line segments connecting the inner via conductors 60 to each other. In the example illustrated in FIG. 9, the openings 35 provided in the second outer electrode layer 32 pass through the midpoints of the line segments connecting the inner via conductors 60 to each other.

When the openings 35 are arranged so as to pass through the midpoints of the line segments connecting the inner via conductors 60 to each other, it is possible to ensure conduction paths between the inner via conductors 60 and the outer electrode layers 30 and improve the process feasibility for forming the inner via conductors 60 or the openings 35.

Alternatively, as illustrated in FIG. 9, in plan view in the thickness direction, the openings 35 provided in the outer electrode layer 30 that encloses the through-hole conductors 40 and inner via conductors 60 may pass through the midpoints of the line segments connecting the through-hole conductors 40 to each other. In the example illustrated in FIG. 9, the openings 35 provided in the second outer electrode layer 32 pass through the midpoints of the line segments connecting the second through-hole conductors 42 to each other.

When the openings 35 are arranged so as to pass through the midpoints of the line segments connecting the through-hole conductors 40 to each other, it is possible to ensure conduction paths between the through-hole conductors 40 and the outer electrode layers 30 and improve the process feasibility for forming the through-hole conductors 40 or the openings 35.

In the example illustrated in FIG. 9, plural openings 35 are arranged in a staggered pattern. However, plural openings 35 may be arranged in a grid pattern, for example.

When plural openings 35 are provided, the plural openings 35 may include an opening 35 that does not pass through any one of the midpoints of the line segments connecting the inner via conductors 60 to each other and may include an opening 35 that does not pass through any one of the midpoints of the line segments connecting the through-hole conductors 40 to each other.

### Fifth Embodiment

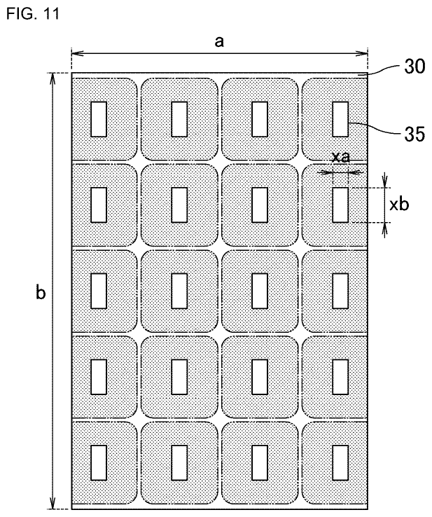

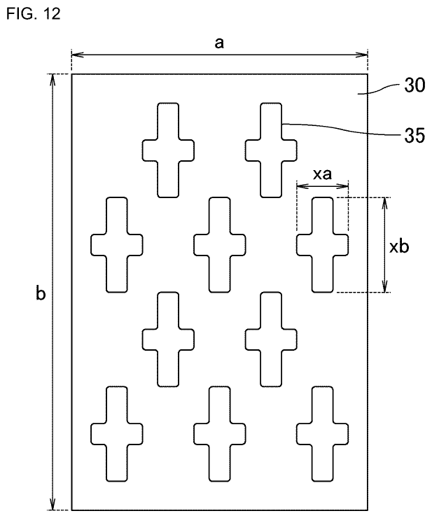

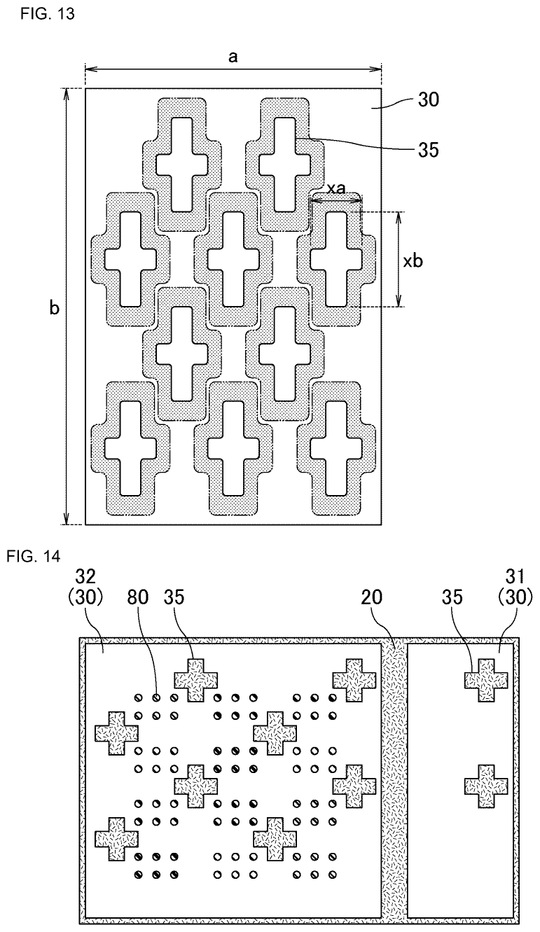

FIG. 10 is a schematic plan view of an example of a capacitor element according to a fifth embodiment of the present disclosure. FIG. 11 is a schematic plan view of regions from which internal moisture escapes in the capacitor element illustrated in FIG. 10. FIG. 12 is a schematic plan view of another example of a capacitor element according to the fifth embodiment of the present disclosure. FIG. 13 is a schematic plan view of regions from which internal moisture escapes in the capacitor element illustrated in FIG. 12.

As illustrated in FIGS. 10 and 12, it is preferable that in plan view in the thickness direction, the length of the openings 35 in the direction along the short side of the outer electrode layer 30 provided with the openings 35 is shorter than that in the direction along the long side of the outer electrode layer 30 provided with the openings 35. To be specific, it is preferable that a<b and xa<xb where a is the length of the short side of the outer electrode layer 30, b is the length of the long side of the outer electrode layer 30, xa is the length of the openings 35 in the direction along the short side of the outer electrode layer 30, and xb is the length of the openings 35 in the direction along the long side of the outer electrode layer 30.

FIGS. 11 and 13 schematically illustrate the regions from which internal moisture escapes. As illustrated in FIGS. 10 and 12, when the short side of the openings 35 is aligned with the short side of the corresponding outer electrode layer 30 and the long side of the openings 35 is aligned with the long side of the outer electrode layer 30, it is possible to efficiently evaporate internal moisture while minimizing the openings 35.

In plan view in the thickness direction, in particular, the aspect ratio of openings 35 is preferably equal to the aspect ratio of the outer electrode layer 30 provided with the openings 35. Herein, the aspect ratio of openings 35 refers to the ratio expressed as xa/xb, and the aspect ratio of the outer electrode layers 30 refers to the ratio expressed as a/b.

When the aspect ratio of openings 35 is set equal to the aspect ratio of the corresponding outer electrode layer 30, it is possible to efficiently evaporate internal moisture while minimizing the openings 35.

In the example illustrated in FIG. 10, the planar shape of the openings 35 is rectangular. In this case, it is preferable that the openings 35 are not arranged in a staggered pattern.

In the example illustrated in FIG. 12, the planar shape of the openings 35 is a cross shape. In this case, it is preferable that the openings 35 are arranged in a staggered pattern.

The outer electrode layer 30 provided with the openings 35 may be either the first outer electrode layer 31 or the second outer electrode layer 32.

When plural openings 35 are provided, the plural openings 35 may include an opening 35 that does not satisfy a<b and xa<xb and may include an opening 35 that has an aspect ratio not equal to that of the corresponding outer electrode layer 30.

### Sixth Embodiment

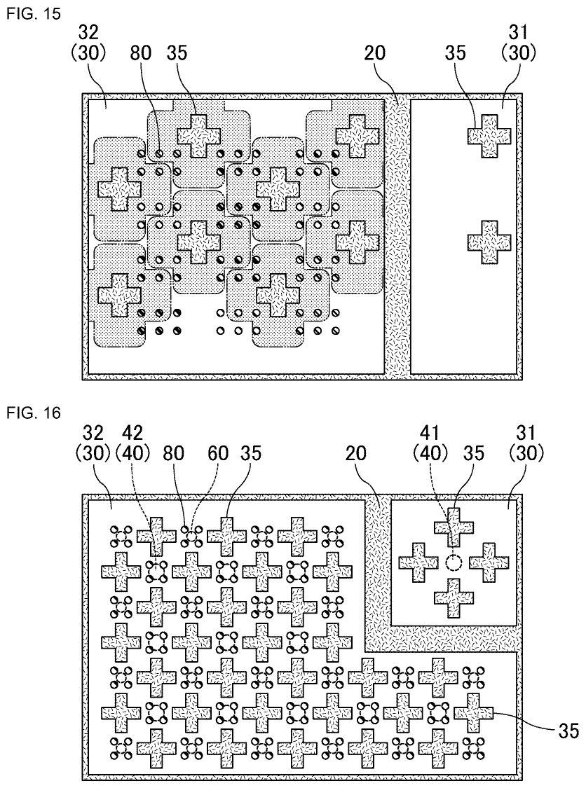

FIG. 14 is a schematic plan view of an example of a capacitor element according to a sixth embodiment of the present disclosure. FIG. 15 is a schematic plan view of regions from which internal moisture escapes in the capacitor element illustrated in FIG. 14.

As illustrated in FIG. 14, in plan view in the thickness direction, plural openings 35 having a cross shape may be arranged in a staggered pattern. In the example illustrated in FIG. 14, the openings 35 provided in the second outer electrode layer 32 are arranged in a staggered pattern.

When the openings 35 have a cross shape, it is possible to efficiently evaporate internal moisture while minimizing the openings 35.

Furthermore, when the openings 35 having a cross shape are arranged in a staggered pattern, it is possible to ensure sufficient areas for forming the outer via conductors 80.

FIG. 16 is a schematic plan view of a capacitor element according to a first modification of the sixth embodiment of the present disclosure.

In the example illustrated in FIG. 16, in plan view in the thickness direction, the openings 35 having a cross shape are parallel or perpendicular to the edge of the outer electrode layer 30 provided with these openings 35. In plan view in the thickness direction, line segments connecting the through-hole conductors 40 (for example, the second through-hole conductors 42) to the inner via conductors 60 are inclined at about 450 to the edge of the corresponding outer electrode layer 30 (for example, the second outer electrode layer 32), and the plural openings 35 having a cross shape are arranged in a staggered pattern.

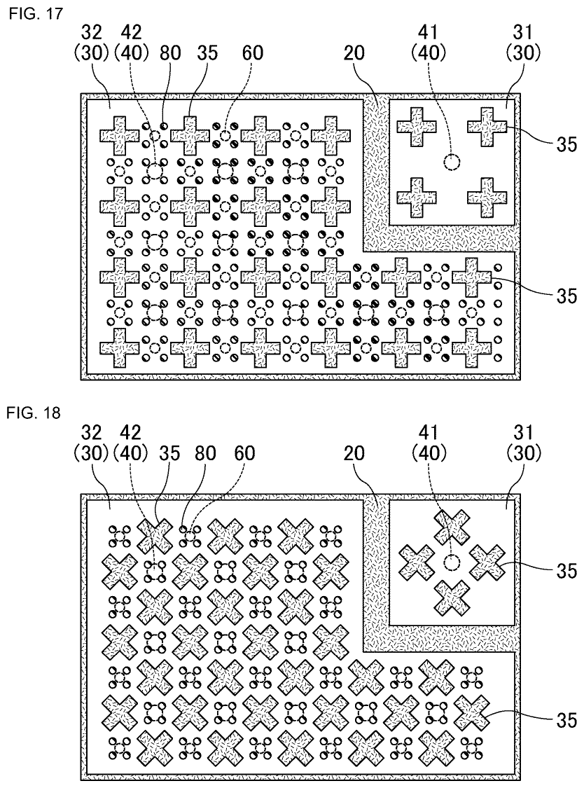

FIG. 17 is a schematic plan view of a capacitor element according to a second modification of the sixth embodiment of the present disclosure.

In the example illustrated in FIG. 17, in plan view in the thickness direction, the openings 35 having a cross shape are parallel or perpendicular to the edge of the outer electrode layer 30 provided with these openings 35. In plan view in the thickness direction, line segments connecting the through-hole conductors 40 (for example, the second through-hole conductors 42) to the inner via conductors 60 are parallel or perpendicular to the edge of the corresponding outer electrode layer 30 (for example, the second outer electrode layer 32), and the plural openings 35 having a cross shape are arranged in a grid pattern.

The regions where the outer via conductors 80 can be formed can be made larger by arranging the plural openings 35 having a cross shape in a grid pattern as illustrated in FIG. 17, compared to a staggered pattern as illustrated in FIG. 16.

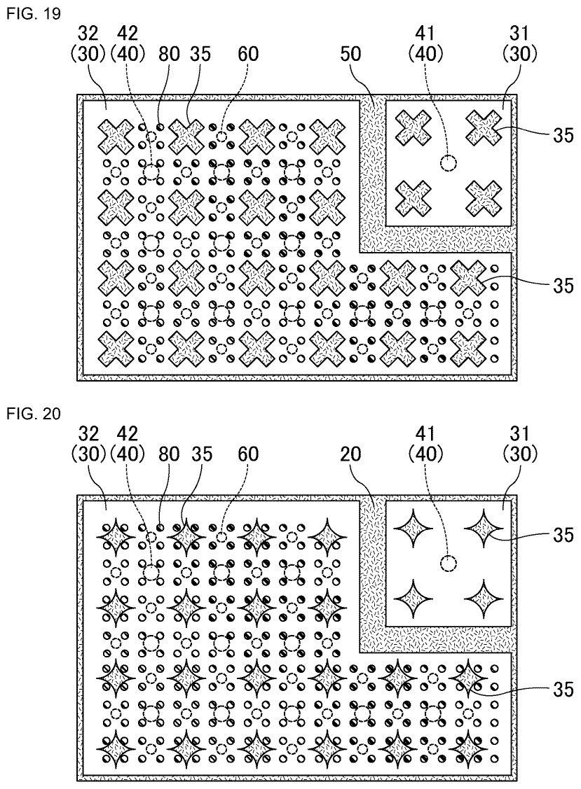

FIG. 18 is a schematic plan view of a capacitor element according to a third modification of the sixth embodiment of the present disclosure. FIG. 19 is a schematic plan view of a capacitor element according to a fourth modification of the sixth embodiment of the present disclosure.

As illustrated in FIGS. 18 and 19, in plan view in the thickness direction, the openings 35 having a cross shape may be inclined to the edge of the outer electrode layer 30 provided with theses openings 35.

When the openings 35 having a cross shape are inclined to the edge of the outer electrode layer 30, it is possible to reduce the loss of internal conduction paths and, furthermore, improve the process feasibility for forming the through-hole conductors 40, inner via conductors 60, or openings 35.

The inclination of the openings 35 to the edge of the outer electrode layer 30 is not particularly limited but is, for example, about greater than or equal to 40° and smaller than or equal to 50°, preferably about 45°.

In the example illustrated in FIG. 18, in plan view in the thickness direction, the line segments connecting the through-hole conductors 40 (for example, each second through-hole conductors 42) to the inner via conductors 60 are inclined at about 45° to the edge of the corresponding outer electrode layer 30 (for example, the second outer electrode layer 32), and the plural openings 35 having a cross shape are arranged in a staggered pattern.

In the example illustrated in FIG. 19, in plan view in the thickness direction, the line segments connecting the through-hole conductors 40 (for example, the second through-hole conductors 42) to the inner via conductors 60 are parallel or perpendicular to the edge of the corresponding outer electrode layer 30 (for example, the second outer electrode layer 32), and the plural openings 35 having a cross shape are arranged in a grid pattern.

The regions where the outer via conductors 80 can be formed can be made larger by arranging the plural openings 35 having a cross shape in a grid pattern as illustrated in FIG. 19, compared to a staggered pattern as illustrated in FIG. 18.

### Seventh Embodiment

FIG. 20 is a schematic plan view of an example of a capacitor element according to a seventh embodiment of the present disclosure.

As illustrated in FIG. 20, in plan view in the thickness direction, the openings 35 may be rounded at the intersection of the cross shape.

When the openings 35 having a cross shape are rounded at the intersection, the area where the outer via conductors 80 can be formed can be made larger.

### Eighth Embodiment

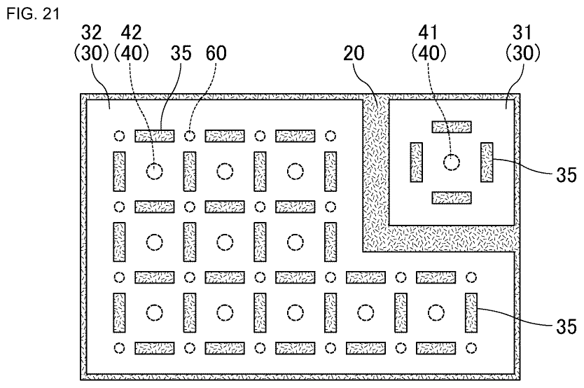

FIG. 21 is a schematic plan view of an example of a capacitor element according to an eighth embodiment of the present disclosure.

As illustrated in FIG. 21, in plan view in the thickness direction, the distance from at least one of the inner via conductors 60 to at least one of the openings 35 provided in the outer electrode layer 30 (for example, the second outer electrode layer 32) that encloses these inner via conductor 60 may be shorter than the distance to the edge of the outer electrode layer 30 (for example, the second outer electrode layer 32) that encloses the inner via conductor 60.

When the openings 35 are arranged near the inner via conductors 60, moisture around the inner via conductors 60 can preferentially be removed.

Hereinafter, the configurations of the capacitor elements 1 and 2 and the like will be described in detail.

The planar shape of the capacitor portion 10 when viewed in the thickness direction can be, for example, rectangles (squares or oblongs), quadrilaterals other than rectangles, polygons such as triangles, pentagons, and hexagons, as well as circles, ellipses, and combinations of these shapes. The planar shape of the capacitor portion 10 may be L-shaped, C-shaped (U-shaped), stair-shaped, or the like.

The anode plate 11 is preferably made of a valve metal that exhibits so-called valve action. Examples of the valve metal are pure metals, such as aluminum, tantalum, niobium, titanium, and zirconium, as well as alloys including at least one of these metals. Of these metals, aluminum or aluminum alloys are preferred.

The shape of the anode plate 11 is preferably a flat-plate shape and more preferably a foil shape. In this specification, the “plate shape” includes the “foil shape”.

The anode plate 11 needs to include the porous portion 11B on at least one of the main surfaces of the core portion 11A. Specifically, the anode plate 11 may include one porous portion 11B on only one of the main surfaces of the core portion 11A or may include porous portions 11B on the respective main surfaces of the core portion 11A. Each porous portion 11B is preferably a porous layer formed on the surface of the core portion 11A and more preferably an etching layer.

The thickness of the anode plate 11 before the etching treatment is preferably greater than or equal to 60 μm and smaller than or equal to 200 μm. The thickness of the core portion 11A remaining unetched after the etching treatment is preferably greater than or equal to 15 μm and smaller than or equal to 70 μm. Although the thickness of the porous portions 11B is designed based on the required withstand voltage and capacitance, it is preferable that the total thickness of the porous portions 11B on respective sides of the core portion 11A is greater than or equal to 10 μm and smaller than or equal to 180 μm.

The pore size of the porous portions 11B is preferably greater than or equal to 10 nm and smaller than or equal to 600 nm. The pore size of the porous portions 11B refers to median diameter (D50) measured by a mercury porosimeter. The pore size of the porous portions 11B can be controlled by, for example, adjusting various etching conditions.

The dielectric layers 13 provided on the surfaces of the porous portions 11B are porous, reflecting the surface state of the porous portions 11B and have a surface profile with fine irregularities. The dielectric layers 13 are preferably composed of oxide coating of the aforementioned valve metal. When the anode plate 11 is composed of aluminum foil, for example, the dielectric layers 13 composed of oxide coating can be formed by performing anodization (also called chemical conversion coating) for the surface of the aluminum foil in an aqueous solution containing ammonium adipate.

The thickness of the dielectric layers 13 is designed based on the required withstand voltage and capacitance but is preferably greater than or equal to 10 nm and smaller than or equal to 100 nm.

When the cathode layer 12 includes the solid electrolytic layer 12A, examples of the material constituting the solid electrolytic layer 12A are conductive polymers, such as polypyrroles, polythiophenes, and polyanilines. Of these materials, polythiophenes are preferred, and poly(3,4-ethylenedioxythiophene) called PEDOT is particularly preferred. The aforementioned conductive polymers may contain a dopant, such as polystyrene sulfonate (PSS). Preferably, the solid electrolytic layer 12A includes an inner layer that fills the pores (dens) in the dielectric layer 13 and an outer layer that covers the dielectric layer 13.

The thickness of the solid electrolytic layer 12A from the surface of the porous portion 11B is preferably greater than or equal to 2 μm and smaller than or equal to 20 μm.

The solid electrolytic layer 12A is formed by, for example, a method of using a treatment liquid containing a monomer such as 3,4-ethylenedioxythiophene to form a polymerized film, such as poly(3,4-ethylenedioxythiophene) on the surfaces of the dielectric layers 13, a method of applying a dispersion of a polymer, such as poly(3,4-ethylenedioxythiophene), to the surface of the dielectric layer 13, followed by drying, or another method.

The solid electrolytic layer 12A can be formed in a predetermined region by applying the aforementioned treatment liquid or dispersion to the surface of the dielectric layer 13 by a method, such as sponge transfer, screen printing, dispensing application, and inkjet printing.

When the cathode layer 12 includes the conductor layer 12B, the conductor layer 12B includes at least one of a conductive resin layer or a metal layer. The conductor layer 12B may include only a conductive resin layer or only a metal layer. Preferably, the conductor layer 12B covers the entire surface of the solid electrolytic layer 12A.

The conductive resin layer is, for example, a conductive adhesive layer containing at least one type of conductive filler selected from a group consisting of a silver filler, a copper filler, a nickel filler, and a carbon filler.

The metal layer is, for example, a metal plating film, a metal foil, or the like. The metal layer is preferably composed of at least one type of metal selected from a group consisting of nickel, copper, silver, and alloys of these metals as the main component. The “main component” refers to the element component with the largest weight ratio.

Each conductor layer 12B includes a carbon layer provided on the surface of the solid electrolytic layer 12A and a copper layer provided on the surface of the carbon layer, for example.

The carbon layer is provided for electrically and mechanically coupling the solid electrolytic layer 12A and the copper layer. The carbon layer can be formed in a desired region by applying carbon paste to the surface of the solid electrolytic layer 12A through a method, such as sponge transfer, screen printing, dispensing application, and inkjet printing. It is preferable that the carbon layer is not yet dry and remains viscous when the copper layer is laminated thereon in the following step. The thickness of the carbon layer is preferably greater than or equal to 2 μm and smaller than or equal to 50 μm.

The copper layer can be formed in a desired region by applying copper paste to the surface of the carbon layer through a method, such as sponge transfer, screen printing, spraying, dispensing application, and inkjet printing. The thickness of the copper layer is preferably greater than or equal to 2 μm and smaller than or equal to 50 μm.

The sealing layer 20 is composed of an insulating material. In this case, the sealing layer 20 is preferably composed of insulating resin.

Examples of the insulating resin constituting the sealing layer 20 are epoxy resin and phenol resin.

Preferably, the sealing layer 20 further contains a filler.

Examples of the filler contained in the sealing layer 20 are inorganic fillers, such as silica particles and alumina particles.

Between the capacitor portion 10 and the sealing layer 20, layers, such as a stress relaxation layer and a moisture barrier film, may be provided, for example.

The insulating mask layer 25 is composed of an insulating material. In this case, the insulating mask layer 25 is preferably composed of insulating resin.

Examples of the insulating resin constituting the insulating mask layer 25 are polyphenylsulfone resin, polyether sulfone resin, cyanate ester resin, fluororesin (tetrafluoroethylene, tetrafluoroethylene-perfluoroalkyl vinyl ether copolymer, and the like), polyimide resin, polyamide-imide resin, epoxy resin, as well as derivatives or precursors thereof.

The insulating mask layer 25 may be composed of the same resin as the sealing layer 20. If the insulating mask layer 25 contain an inorganic filler, the inorganic filler may have a negative effect on the capacitance active region of the capacitor portion 10 unlike the sealing layer 20. It is therefore preferable that the insulating mask layer 25 is composed of a resin-only system.

The insulating mask layer 25 can be formed in a desired region by, for example, applying a mask material, such as a composition containing insulating resin, to the surface of the porous portion 11B through a method, such as sponge transfer, screen printing, dispensing application, and inkjet printing.

The insulating mask layer 25 may be formed for the porous portion 11B before the dielectric layer 13 is formed or may be formed after the dielectric layer 13 is formed.

The first outer electrode layer 31 is electrically coupled to the anode plate 11. In the example illustrated in FIG. 1, the first outer electrode layer 31 is provided on the surface of the first through-hole conductor 41 and serves as a connection terminal of the capacitor portion 10. In the example illustrated in FIG. 1, the first outer electrode layer 31 is electrically coupled to the anode plate 11 through the first through-hole conductor 41 and serves as a connection terminal for the anode plate 11.

The constituent material of the first outer electrode layer 31 is a metal material containing a metal with low resistance, such as silver, gold, or copper, for example. In this case, the first outer electrode layer 31 is formed by, for example, plating the surface of the first through-hole conductor 41.

In order to improve the adhesion between the first outer electrode layer 31 and other members, that is, adhesion between the first outer electrode layer 31 and the first through-hole conductor 41 herein, the constituent material of the first outer electrode layer 31 may be a mixture of resin and at least one type of conductive filler selected from a group consisting of a silver filler, a copper filler, a nickel filler, and a carbon filler.

The second outer electrode layer 32 is electrically coupled to the cathode layer 12. In the example illustrated in FIG. 1, the second outer electrode layer 32 is provided on the surface of the second through-hole conductor 42 and serves as a connection terminal of the capacitor portion 10.

The constituent material of the second outer electrode layer 32 is a metal material containing a metal with low resistance, such as silver, gold, or copper, for example. In this case, the second outer electrode layer 32 is formed by, for example, plating the surface of the second through-hole conductor 42.

In order to improve the adhesion between the second outer electrode layer 32 and other members, that is, adhesion between the second outer electrode layer 32 and the second through-hole conductor 42 herein, the constituent material of the second outer electrode layer 32 may be a mixture of resin and at least one type of conductive filler selected from a group consisting of a silver filler, a copper filler, a nickel filler, and a carbon filler.

The constituent materials of the first and second outer electrode layers 31 and 32 are preferably the same at least in terms of type, but may be different from each other.

In the example illustrated in FIG. 1, each of the plural capacitor portions 10 includes the first outer electrode layer 31 electrically coupled to the anode plate 11 and the second outer electrode layer 32 electrically coupled to the cathode layers 12. However, plural capacitor portions 10 may share at least one of the first or second outer electrode layer 31 or 32.

In the example illustrated in FIG. 1, the first and second outer electrode layers 31 and 32 are provided on both main surfaces of the sealing layer 20 but may be provided on only one of the main surfaces of the sealing layer 20.

In the example illustrated in FIG. 1, the second through-hole conductor 42 is electrically coupled to the cathode layers 12 through the second outer electrode layer 32 and inner via conductors 60.

In the example illustrated in FIG. 1, the second outer electrode layer 32 is electrically coupled to the cathode layers 12 through the inner via conductors 60 and serves as a connection terminal for the cathode layers 12.

Preferably, the first through-hole conductor 41 is electrically coupled to the anode plate 11 through the inner wall surface of the first through-hole 51. To be more specific, it is preferable that the first through-hole conductor 41 is electrically coupled to the end face of the anode plate 11 that faces the inner wall surface of the first through-hole 51 in the in-plane direction. The anode plate 11 is thereby electrically led out to the outside through the first through-hole conductor 41.

It is preferable that the core portion 11A and porous portion 11B are exposed in the end face of the anode plate 11 electrically coupled to the first through-hole conductor 41. In this case, the porous portion 11B is also electrically coupled to the first through-hole conductor 41 in addition to the core portion 11A.

When viewed in the thickness direction, it is preferable that the first through-hole conductor 41 is electrically coupled to the anode plate 11 over the entire circumference of the first through-hole 51. In this case, the connection resistance between the anode plate 11 and the first through-hole conductor 41 tends to decrease, and the equivalent serial resistance (ESR) tends to decrease.

The first through-hole conductor 41 is formed in the following manner, for example. First, the first through-hole 51, which penetrates the capacitor portion 10 and sealing layer 20 in the thickness direction, is formed by drilling, laser processing, or the like. Then, the first through-hole conductor 41 is formed by metalizing the inner wall surface of the first through-hole 51 with a metal material containing a metal with low resistance, such as copper, gold, and silver. In the process of forming the first through-hole conductor 41, the processing is facilitated by, for example, metalizing the inner wall surface of the first through-hole 51 through methods, such as electroless copper plating and electrolytic copper plating. The method of forming the first through-hole conductor 41 may also be a method of filling the first through-hole 51 with a metal material, a composite material of metal and resin, or the like, in addition to the method of metalizing the inner wall surface of the first through-hole 51.

Between the anode plate 11 and the first through-hole conductor 41 in the in-plane direction, an anode connection layer may be provided. That is, the anode plate 11 and the first through-hole conductor 41 may be electrically coupled with the anode connection layer interposed therebetween.

When the anode connection layer is provided between the anode plate 11 and the first through-hole conductor 41 in the in-plane direction, the anode connection layer serves as a barrier layer for the anode plate 11, to be more specific, a barrier layer for the core portion 11A and porous portion 11B. The anode connection layer serving as the barrier layer for the anode plate 11 reduces dissolution of the anode plate 11 that occurs during the chemical liquid treatment for forming the outer electrode layers 30 (for example, the first outer electrode layer 31) and thereby reduces entering of the chemical liquid into the capacitor portion 10. As a result, the reliability tends to improve.

The anode connection layer preferably includes a layer made of nickel as the main component. In this case, the metal (for example, aluminum) constituting the anode plate 11 is less damaged, and the barrier properties of the anode connection layer for the anode plate 11 tends to improve.

The anode connection layer does not need to be provided between the anode plate 11 and the first through-hole conductor 41 in the in-plane direction. In this case, the first through-hole conductor 41 may be directly coupled to the end face of the anode plate 11.

When the first through-hole conductor 41 is provided only on the inner wall surface of the first through-hole 51, the first through-hole 51 may be provided with a resin-filled portion that is filled with a resin material. The resin-filled portion is provided in space surrounded by the first through-hole conductor 41 inside the first through-hole 51. When the resin-filled portion is provided and eliminates the space inside the first through-hole 51, occurrence of delamination of the first through-hole conductor 41 is reduced. The resin-filled portion may be either a conductor or an insulator.

The second through-hole conductor 42 is formed in the following manner, for example. First, a through-hole that penetrates the capacitor portion 10 in the thickness direction is formed by drilling, laser processing, or the like. Then, the aforementioned through-hole is filled with an insulating material. The second through-hole 52 is formed by performing drilling, laser processing, or the like for the portion filled with the insulating material. In this process, the diameter of the second through-hole 52 is set smaller than the diameter of the through-hole filled with the insulating material, so that the insulating material remains between the inner wall surface of the through-hole formed first and the inner wall surface of the second through-hole 52 in the in-plane direction. Thereafter, the second through-hole conductor 42 is formed by metalizing the inner wall surface of the second through-hole 52 with a metal material containing a metal with low resistance, such as copper, gold, and silver. In the process of forming the second through-hole conductor 42, the processing is facilitated by, for example, metallizing the inner wall surface of the second through-hole 52 through methods, such as electroless copper plating and electrolytic copper plating. The method of forming the second through-hole conductor 42 may also be a method of filling the second through-hole 52 with a metal material, a composite material of metal and resin, or the like, in addition to the method of metalizing the inner wall surface of the second through-hole 52.

When the second through-hole conductor 42 is provided only on the inner wall surface of the second through-hole 52, the second through-hole 52 may be provided with a resin-filled portion that is filled with a resin material. The resin-filled portion is provided in space surrounded by the second through-hole conductor 42 inside the second through-hole 52. When the resin-filled portion is provided and eliminates the space inside the second through-hole 52, the occurrence of delamination of the second through-hole conductor 42 is reduced. The resin-filled portion may be either a conductor or an insulator.

The constituent material of the inner via conductors 60 is a metal material containing a metal with low resistance, such as silver, gold, or copper, for example.

The inner via conductors 60 are formed by, for example, plating the inner wall surface of through-holes that penetrate the sealing layer 20 in the thickness direction with the aforementioned metal material or filling the through-holes with conductive paste, followed by heat treatment.

The outer insulating layers 70 are composed of an insulating material. In this case, the outer insulating layers 70 are preferably composed of insulating resin. The outer insulating layers 70 may be composed of the same resin as the sealing layer 20.

The constituent material of the outer via conductors 80 is a metal material containing a metal with low resistance, such as silver, gold, or copper, for example. The outer via conductors 80 may be composed of the same metal as the inner via conductors 60.

The outer via conductors 80 are formed by, for example, plating the inner wall surface of through-holes that penetrate the outer insulating layers 70 in the thickness direction with the aforementioned metal material or filling the through-holes with conductive paste, followed by heat treatment.

### Other Embodiment

The capacitor element of the present disclosure is not limited to the aforementioned embodiments and can be applied and modified in various ways regarding the capacitor element configuration, manufacturing conditions, and other factors within the scope of the present disclosure.

The capacitor element of the present disclosure may include a single capacitor portion arranged inside the sealing layer or may include plural capacitor portions.

In the capacitor element of the present disclosure, when plural capacitor portions are arranged inside the sealing layer, adjacent capacitor portions need to be separated physically. Therefore, adjacent capacitor portions may be electrically separated or may be electrically coupled. It is preferable that the portion separating adjacent capacitor portions is filled with an insulting material constituting, for example, the sealing layer. The spacing between adjacent capacitor portions may be constant in the thickness direction or may decrease in the thickness direction.

In the capacitor element of the present disclosure, when plural capacitor portions are arranged inside the sealing layer, the plural capacitor portions may be arranged to be aligned in the in-plane direction, arranged to be stacked in the thickness direction, or arranged in a combination of both. The plural capacitor portions may be arranged regularly or irregularly. The size, shape, and the like of each capacitor element may be the same, or some or all of them may be different. The capacitor elements preferably have the same configuration but may include a capacitor element having a different configuration.

The capacitor element of the present disclosure can be suitably used as a constituent material of a composite electronic component. Such a composite electronic component includes, for example, the capacitor element of the present disclosure, outer electrode layers that are provided on the sealing layer of the capacitor element and are electrically coupled to the anode plate and cathode layer of the capacitor element, and an electronic component coupled to the outer electrode layers.

In the composite electronic component, the electronic component coupled to the outer electrode layers may be either a passive or an active element. The outer electrode layers may be coupled to both the passive and active elements or to one of the passive or active element. Alternatively, the outer electrode layers may be coupled to a composite component of passive and active elements.

The passive element is an inductor, for example. The active element is a memory, a graphical processing unit (GPU), a central processing unit (CPU), a micro-processing unit (MPU), a power management IC (PMIC), or the like.

The capacitor element of the present disclosure has a sheet-like shape as a whole. In the composite electronic component, therefore, the capacitor element can be treated like a mounting board, and electronic components can be mounted on the capacitor element. Furthermore, by forming the electronic components mounted on the capacitor element into a sheet-like shape, the capacitor element and the electronic components can be coupled in the thickness direction via a through-hole conductor penetrating each electronic component. As a result, active and passive elements can be configured together like an integrated module.

For example, a switching regulator can be formed by electrically connecting the capacitor element of the present disclosure between a voltage regulator including semiconductor active elements and a load supplied with converted DC voltage.

In the composite electronic component, a circuit layer formed on one side of a capacitor matrix sheet in which a plurality of the capacitor elements of the present disclosure are arranged may be coupled to a passive or active element.

Furthermore, the capacitor element of the present disclosure may be placed in a cavity previously provided in the substrate and embedded in resin, and then a circuit layer may be formed on the resin. In another cavity of the same substrate, another electronic component (a passive or active element) may be mounted.

Alternatively, the capacitor element of the present disclosure may be mounted on a smooth carrier, such as a wafer or glass, an outer layer made of resin may be formed, and then a circuit layer may be formed, after which the capacitor element may be coupled to a passive or active element.

The specification discloses the following matters.

<1> A capacitor element including: a capacitor portion including: an anode plate having a core portion and a porous portion on at least one main surface of the core portion; a dielectric layer on a surface of the porous portion; and a cathode layer on a surface of the dielectric layer; a sealing layer covering the capacitor portion; and an outer electrode layer on a surface of the sealing layer and electrically coupled to the anode plate or the cathode layer, wherein the outer electrode layer includes at least one opening penetrating the outer electrode layer in a thickness direction thereof.

<2> The capacitor element according to <1>, wherein the at least one opening in the outer electrode layer includes a plurality of openings.

<3> The capacitor element according to <2>, wherein the sealing layer includes a first sealing layer on a first main surface of the capacitor portion and a second sealing layer on a second main surface of the capacitor portion, the first main surface facing the second main surface in the thickness direction, the outer electrode layer includes a first outer electrode on the first sealing layer and a second outer electrode on the second sealing layer, and the at least one opening includes a first opening in the first outer electrode layer and a second opening in the second outer electrode layer.

<4> The capacitor element according to any one of <1> to <3>, wherein in a plan view in the thickness direction, an area of the at least one opening is greater than or equal to 5% of an area enclosed by a peripheral edge of the outer electrode.

<5> The capacitor element according to any one of <1> to <4>, wherein in a plan view in the thickness direction, a maximum width of the at least one opening is greater than or equal to 5% of a length of a short side of the outer electrode layer.

<6> The capacitor element according to any one of <1> to <5>, wherein in a plan view in the thickness direction, a maximum width of the at least one opening is greater than or equal to 10 μm.

<7> The capacitor element according to any one of <1> to <6>, further comprising a through-hole conductor penetrating the capacitor portion and the sealing layer in the thickness direction and electrically coupled to the anode plate or the cathode layer, the through-hole conductor having ends each exposed to the surface of the sealing layer, wherein in a plan view in the thickness direction, the at least one opening does not overlap the through-hole conductor.

<8> The capacitor element according to any one of <1> to <7>, further comprising an inner via conductor penetrating the sealing layer in the thickness direction and electrically coupled to the anode plate or the cathode layer, the inner via conductor having an end exposed to the surface of the sealing layer, wherein in a plan view in the thickness direction, the at least one opening does not overlap the inner via conductor.

<9> The capacitor element according to any one of <1> to <8>, further including: through-hole conductors each of which penetrates the capacitor portion and the sealing layer in the thickness direction and is electrically coupled to the anode plate or the cathode layer and has ends each exposed to the surface of the sealing layer; and inner via conductors each of which penetrates the sealing layer in the thickness direction and is electrically coupled to the anode plate or the cathode layer and has an end exposed to the surface of the sealing layer, wherein in a plan view in the thickness direction, the at least one opening in the outer electrode layer enclosing the through-hole conductors and the inner via conductors is not located on line segments connecting the through-hole conductors to the inner via conductors.

<10> The capacitor element according to <9>, wherein in the plan view in the thickness direction, the at least one opening in the outer electrode layer that encloses the through-hole conductors and the inner via conductors passes through a midpoint of any line segment connecting the inner via conductors to each other.

<11> The capacitor element according to <9> or <10>, wherein in the plan view in the thickness direction, the at least one opening in the outer electrode layer that encloses the through-hole conductors and the inner via conductors passes through a midpoint of any line segment connecting the through-hole conductors to each other.

<12> The capacitor element according to any one of <1> to <11>, wherein in a plan view in the thickness direction, a length of the at least one opening in a direction along a short side of the outer electrode layer is shorter than a length of the opening in a direction along a long side of the outer electrode layer.

<13> The capacitor element according to any one of <1> to <12>, wherein in a plan view in the thickness direction, an aspect ratio of the at least one opening is equal to an aspect ratio of the outer electrode layer.

<14> The capacitor element according to any one of <1> to <13>, wherein in a plan view in the thickness direction, the at least one opening has a shape that combines a straight line and a curve.

<15> The capacitor element according to <14>, wherein in the plan view in the thickness direction, the at least one opening has a rounded tip.

<16> The capacitor element according to any one of <1> to <15>, wherein in a plan view in the thickness direction, the at least one opening has a cross shape.

<17> The capacitor element according to <16>, wherein in the plan view in the thickness direction, the at least one opening includes a plurality of openings having the cross shape and arranged in a staggered pattern.

<18> The capacitor element according to <16> or <17>, wherein in the plan view in the thickness direction, the at least one opening having the cross shape is inclined with respect to an edge of the outer electrode layer.

<19> The capacitor element according to any one of <16> to <18>, wherein in the plan view in the thickness direction, the at least one opening includes a plurality of openings having the cross shape and arranged in a grid pattern.

<20> The capacitor element according to any one of <16> to <19>, wherein in the plan view in the thickness direction, the cross shape has an intersection of which is rounded.

<21> The capacitor element according to any one of <1> to <20>, further comprising inner via conductors each of which penetrates the sealing layer in the thickness direction and are electrically coupled to the anode plate or the cathode layer and have ends exposed to the surface of the sealing layer, wherein in a plan view in the thickness direction, a distance from at least one of the inner via conductors to the at least one opening in the outer electrode layer that encloses the at least one of the inner via conductors is shorter than a distance to an edge of the outer electrode layer that encloses the at least one of the inner via conductors.

<22> The capacitor element according to any one of <1> to <21>, further including: an outer insulating layer covering the sealing layer and the outer electrode layer; and an outer via conductor penetrating the outer insulating layer in the thickness direction and having an end thereof coupled to the outer electrode layer.

<23> The capacitor element according to <22>, wherein in plan a view in the thickness direction, the at least one opening does not overlap the outer via conductor.

<24> The capacitor element according to <22> or <23>, further including a through-hole conductor that penetrates the capacitor portion and the sealing layer in the thickness direction and is electrically coupled to the anode plate or the cathode layer and has ends each exposed to the surface of the sealing layer, wherein in the plan view in the thickness direction, the at least one opening in the outer electrode layer that encloses the through-hole conductor is not located on a line segment connecting the outer via conductor and the through-hole conductor.

<25> The capacitor element according to any one of <22> to <24>, further including an inner via conductor that penetrates the sealing layer in the thickness direction and is electrically coupled to the anode plate or the cathode layer and has an end exposed to the surface of the sealing layer, wherein in the plan view in the thickness direction, the at least one opening in the outer electrode layer that encloses the inner via conductor is not located on a line segment connecting the outer via conductor to the inner via conductor.

### REFERENCE SIGNS LIST

1, 2 CAPACITOR ELEMENT
10 CAPACITOR PORTION
11 ANODE PLATE
11A CORE PORTION
11B POROUS PORTION
12 CATHODE LAYER
12A SOLID ELECTROLYTIC LAYER
12B CONDUCTOR LAYER
13 DIELECTRIC LAYER
20 SEALING LAYER
25 INSULATING MASK LAYER
30 OUTER ELECTRODE LAYER
31 FIRST OUTER ELECTRODE LAYER
32 SECOND OUTER ELECTRODE LAYER
35 OPENING
40 THROUGH-HOLE CONDUCTOR
41 FIRST THROUGH-HOLE CONDUCTOR
42 SECOND THROUGH-HOLE CONDUCTOR
51 FIRST THROUGH-HOLE
52 SECOND THROUGH-HOLE
60 INNER VIA CONDUCTOR
70 OUTER INSULATING LAYER
80 OUTER VIA CONDUCTOR

1. A capacitor element comprising:
a capacitor portion including: an anode plate having a core portion and a porous portion on at least one main surface of the core portion; a dielectric layer on a surface of the porous portion; and a cathode layer on a surface of the dielectric layer;
a sealing layer covering the capacitor portion; and
an outer electrode layer on a surface of the sealing layer and electrically coupled to the anode plate or the cathode layer, wherein
the outer electrode layer includes at least one opening penetrating the outer electrode layer in a thickness direction thereof.

2. The capacitor element according to claim 1, wherein the at least one opening in the outer electrode layer includes a plurality of openings.

3. The capacitor element according to claim 1, wherein
the sealing layer includes a first sealing layer on a first main surface of the capacitor portion and a second sealing layer on a second main surface of the capacitor portion, the first main surface facing the second main surface in the thickness direction,
the outer electrode layer includes a first outer electrode on the first sealing layer and a second outer electrode on the second sealing layer, and
the at least one opening includes a first opening in the first outer electrode layer and a second opening in the second outer electrode layer.

4. The capacitor element according to claim 1, wherein in a plan view in the thickness direction, an area of the at least one opening is greater than or equal to 5% of an area enclosed by a peripheral edge of the outer electrode.

5. The capacitor element according to claim 1, wherein in a plan view in the thickness direction, a maximum width of the at least one opening is greater than or equal to 5% of a length of a short side of the outer electrode layer.

6. The capacitor element according to claim 1, wherein in a plan view in the thickness direction, a maximum width of the at least one opening is greater than or equal to 10 μm.

7. The capacitor element according to claim 1, further comprising a through-hole conductor penetrating the capacitor portion and the sealing layer in the thickness direction and electrically coupled to the anode plate or the cathode layer, the through-hole conductor having ends each exposed to the surface of the sealing layer, wherein
in a plan view in the thickness direction, the at least one opening does not overlap the through-hole conductor.

8. The capacitor element according to claim 1, further comprising an inner via conductor penetrating the sealing layer in the thickness direction and electrically coupled to the anode plate or the cathode layer, the inner via conductor having an end exposed to the surface of the sealing layer, wherein
in a plan view in the thickness direction, the at least one opening does not overlap the inner via conductor.

9. The capacitor element according to claim 1, further comprising:
through-hole conductors each of which penetrates the capacitor portion and the sealing layer in the thickness direction and is electrically coupled to the anode plate or the cathode layer and has ends each exposed to the surface of the sealing layer; and
inner via conductors each of which penetrates the sealing layer in the thickness direction and is electrically coupled to the anode plate or the cathode layer and has an end exposed to the surface of the sealing layer, wherein
in a plan view in the thickness direction, the at least one opening in the outer electrode layer enclosing the through-hole conductors and the inner via conductors is not located on line segments connecting the through-hole conductors to the inner via conductors.

10. The capacitor element according to claim 9, wherein in the plan view in the thickness direction, the at least one opening in the outer electrode layer that encloses the through-hole conductors and the inner via conductors passes through a midpoint of any line segment connecting the inner via conductors to each other.

11. The capacitor element according to claim 9, wherein in the plan view in the thickness direction, the at least one opening in the outer electrode layer that encloses the through-hole conductors and the inner via conductors passes through a midpoint of any line segment connecting the through-hole conductors to each other.

12. The capacitor element according to claim 1, wherein in a plan view in the thickness direction, a length of the at least one opening in a direction along a short side of the outer electrode layer is shorter than a length of the opening in a direction along a long side of the outer electrode layer.

13. The capacitor element according to claim 1, wherein in a plan view in the thickness direction, an aspect ratio of the at least one opening is equal to an aspect ratio of the outer electrode layer.

14. The capacitor element according to claim 1, wherein in a plan view in the thickness direction, the at least one opening has a shape that combines a straight line and a curve.

15. The capacitor element according to claim 14, wherein in the plan view in the thickness direction, the at least one opening has a rounded tip.

16. The capacitor element according to claim 1, wherein in a plan view in the thickness direction, the at least one opening has a cross shape.

17. The capacitor element according to claim 16, wherein in the plan view in the thickness direction, the at least one opening includes a plurality of openings having the cross shape and arranged in a staggered pattern.

18. The capacitor element according to claim 16, wherein in the plan view in the thickness direction, the at least one opening having the cross shape is inclined with respect to an edge of the outer electrode layer.

19. The capacitor element according to claim 16, wherein in the plan view in the thickness direction, the at least one opening includes a plurality of openings having the cross shape and arranged in a grid pattern.

20. The capacitor element according to claim 16, wherein in the plan view in the thickness direction, the cross shape has an intersection of which is rounded.

21. The capacitor element according to claim 1, further comprising inner via conductors each of which penetrates the sealing layer in the thickness direction and are electrically coupled to the anode plate or the cathode layer and have ends exposed to the surface of the sealing layer, wherein
in a plan view in the thickness direction, a distance from at least one of the inner via conductors to the at least one opening in the outer electrode layer that encloses the at least one of the inner via conductors is shorter than a distance to an edge of the outer electrode layer that encloses the at least one of the inner via conductors.

22. The capacitor element according to claim 1, further comprising:
an outer insulating layer covering the sealing layer and the outer electrode layer; and
an outer via conductor penetrating the outer insulating layer in the thickness direction and having an end thereof coupled to the outer electrode layer.

23. The capacitor element according to claim 22, wherein in plan a view in the thickness direction, the at least one opening does not overlap the outer via conductor.

24. The capacitor element according to claim 22, further comprising a through-hole conductor that penetrates the capacitor portion and the sealing layer in the thickness direction and is electrically coupled to the anode plate or the cathode layer and has ends each exposed to the surface of the sealing layer, wherein
in the plan view in the thickness direction, the at least one opening in the outer electrode layer that encloses the through-hole conductor is not located on a line segment connecting the outer via conductor and the through-hole conductor.

25. The capacitor element according to claim 22, further comprising an inner via conductor that penetrates the sealing layer in the thickness direction and is electrically coupled to the anode plate or the cathode layer and has an end exposed to the surface of the sealing layer, wherein
in the plan view in the thickness direction, the at least one opening in the outer electrode layer that encloses the inner via conductor is not located on a line segment connecting the outer via conductor to the inner via conductor.
